(19) United States
(12) Patent Application Publication
(10) Pub. No.: US 2025/0023756 A1
(43) Pub. Date: Jan. 16, 2025

(54) METHODS AND APPARATUS TO FACILITATE DETERMINATION OF LEADER AND FOLLOWER FOR A SHARED INTERFACE

(71) Applicant: Texas Instruments Incorporated, Dallas, TX (US)

(72) Inventors: Win Naing Maung, Plano, TX (US); James Skidmore, Frisco, TX (US); Roy Wojciechowski, Round Rock, TX (US)

(21) Appl. No.: 18/525,376

(22) Filed: Nov. 30, 2023

Related U.S. Application Data
(60) Provisional application No. 63/525,729, filed on Jul. 10, 2023.

(51) Int. Cl. H04L 12/407

(52) U.S. Cl. CPC H04L 12/407

(57) ABSTRACT

Methods, apparatus, systems, and articles of manufacture are described to facilitate determination of leader and follower for a shared interface. An example first physical layer includes interface circuitry configured to transmit a first signal to a second physical layer; comparator circuitry configured to compare a second signal from the second physical layer to the first signal; and configuration circuitry configured to facilitate operation as a leader or a follower based on the comparison.

### CROSS-REFERENCE TO RELATED APPLICATION

This patent application claims the benefit of and priority to U.S. Provisional Patent Application No. 63/525,729, which was filed on Jul. 10, 2023, which is hereby incorporated herein by reference in its entirety.

### TECHNICAL FIELD

This description relates generally to circuits, and, more particularly, to methods and apparatus to facilitate determination of leader and follower for a shared interface.

### BACKGROUND

Devices that are connected via a shared interface use the shared interface to transmit and receive data. To facilitate the transmission and reception of data via the same shared interface, connected devices may perform initialization and/or link training protocols. During initialization and/or link training protocols the physical layers of one of the connected devices operate as a leader and the other connected devices operate as followers. The leader generates a clock signal, performs synchronization operations, and performs framing for the follower devices. A follower device obtains data from the leader device and is configured based on the information from the leader device.

### SUMMARY

An example of the description includes a first physical layer which includes interface circuitry configured to transmit a first signal to a second physical layer; comparator circuitry configured to compare a second signal from the second physical layer to the first signal; and configuration circuitry configured to facilitate operation as a leader or a follower based on the comparison.

### BRIEF DESCRIPTION OF THE DRAWINGS

FIG. 1 is an example system to implement a physical layer in conjunction with examples described herein.

FIG. 2 is an example implementation of the physical layer in a vehicle.

FIG. 3 is a block diagram of an auto-determination circuitry of FIGS. 1 and/or 2.

FIG. 4 is a flowchart representative of a method and/or operations that may be executed to implement the auto-determination circuitry of FIGS. 1-3.

FIGS. 5A-5C illustrate a flowchart representative of a method and/or operations that may be executed to implement the auto-determination circuitry of FIGS. 1-3.

FIG. 6 is a timing diagram illustrating two example toning signals that can be output by the physical layers of FIG. 1

The same reference numbers or other reference designators are used in the drawings to designate the same or similar (functionally and/or structurally) features.

### DETAILED DESCRIPTION

The drawings are not necessarily to scale. Generally, the same reference numbers in the drawing(s) and this description refer to the same or like parts. Although the drawings show regions with clean lines and boundaries, some or all of these lines and/or boundaries may be idealized. In reality, the boundaries and/or lines may be unobservable, blended and/or irregular.

In some systems, such as automotive systems, devices communicate with each other via a network connection. A network connection may include an Ethernet connection, a wired bus, or any other wired or wireless connection. Some network connections include a physical full-duplex interface that facilitates transmission and reception of data on the same shared interface, rather than dedicating one interface for data transmission and a second interface for data reception. For example, connections that correspond to the institute of Electrical and Electronic Engineers (IEEE) 802.3bw standard and/or the 100BASE-T1 standard utilize a physical full-duplex Ethernet shared interface. Using a shared interface reduces overall cable weight which can reduce material cost, system weight, complexity, and improve fuel efficiency. To facilitate the use of a shared interface, the physical layer (PHY) devices of the connected devices perform link draining and/or a connection establishment protocol. After the PHYs connect, the PHYs perform the link training process and establishment of transmission parameters (frequency, phase, etc.) so that the devices can communicate and/or perform hybrid or echo cancellation. To perform link training, one of the PHY devices is configured to operate as a leader PHY and the other PHY device(s) is/are configured to operate as a follower PHY device(s). A leader PHY is a PHY that, during link training and/or initialization, is the first device to provide a training sequence for the follower device to use during training. After the follower is trained, the follower PHY provides a training sequence to the leader PHY to use during training.

In some systems, the connected PHYs are pre-initiated with leader/follower roles. For example, when the system is first put into place, a user and/or manufacturer will preselect and program one PHY to always operate as the leader during linking training and/or initialization and will select the other PHY(s) to always operate as follower(s) during link training and/or initialization. However, such systems do not have a protocol for selecting a follower or leader. Accordingly, new devices with PHYs cannot be connected and/or added to the system because the leader follower relationship of the previous setup has already been configured and cannot be reconfigured. Examples described herein facilitate a leader follower determination protocol for determining which PHY will operate as the leader and which PHY(s) will operate as the follower(s) so that link training and/or initialization can occur when components are added, removed, or adjusted in a system.

During the leader follower determination protocol, examples described herein cause each connected PHY to output a toning signal. The toning signal is structured to try to be unique for each PHY. For example, each PHY can generate a random number and/or utilize a unique identifier or other unique feature of the PHY or a device implementing the PHY. The PHY then generates the toning signal with characteristic(s) based on the random number and/or unique identifier. For example, the toning signal can include a delay, an amplitude, a frequency, etc. that is based on the random number and/or unique identifier. In this manner, each toning signal for each connected PHY should be distinct. During the leader follower determination protocol, the PHYs each output the generated toning signal. In this manner, each PHY can obtain one or more toning signals from other PHYs and compare the obtained toning signals with the generated toning signal to determine if the PHY should operate as a leader or follower. For example, if comparing delay, a PHY can compare the amount of delay in an obtained signal from another PHY to the amount of delay in the locally generated toning signal. In this manner, the PHY can determine whether to operate as a leader or follower based on the comparison. For example, if the delay of the locally generated signal is smaller than the delay of the obtained toning signals, the PHY can configure itself to operate as a leader. If the delay of the locally generated signal is larger than the delay of one of the obtained toning signals, the PHY can configure itself to operate as a follower. Using examples described herein, systems that utilize shared interface, including automotive Ethernet, can be configured and/or reconfigured to operate with different configurations corresponding to topology changes, modulate replacements, recovery via redundant connection, etc. Additionally, the leader follower determination protocol described herein is fully functional with legacy devices that are not capable of performing the leader follower determination protocol. Although examples described herein are described in conjunction with an automotive Ethernet interface, examples described herein can be used in any technology in which the determination of a leader and follower is desired.

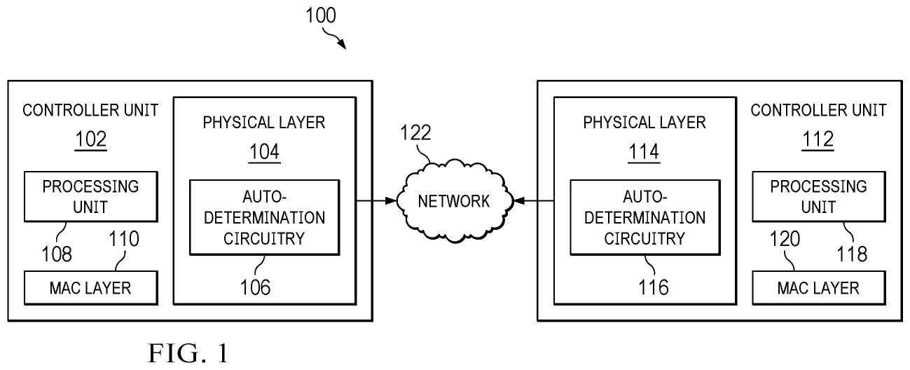

FIG. 1 illustrates an example system 100 for facilitating a leader follower determination protocol. The example system 100 includes example controller units 102, 112, example physical layers (PHYs) 104, 114, example auto-determination circuitries 106, 116, example processing units 108, 118, example media access control (MAC) layers 110, 120, and an example network 122. Although the system 100 of FIG. 1 includes two controller units, there may be any number of controller units with PHYs and auto-determination circuitries connected via the network 122.

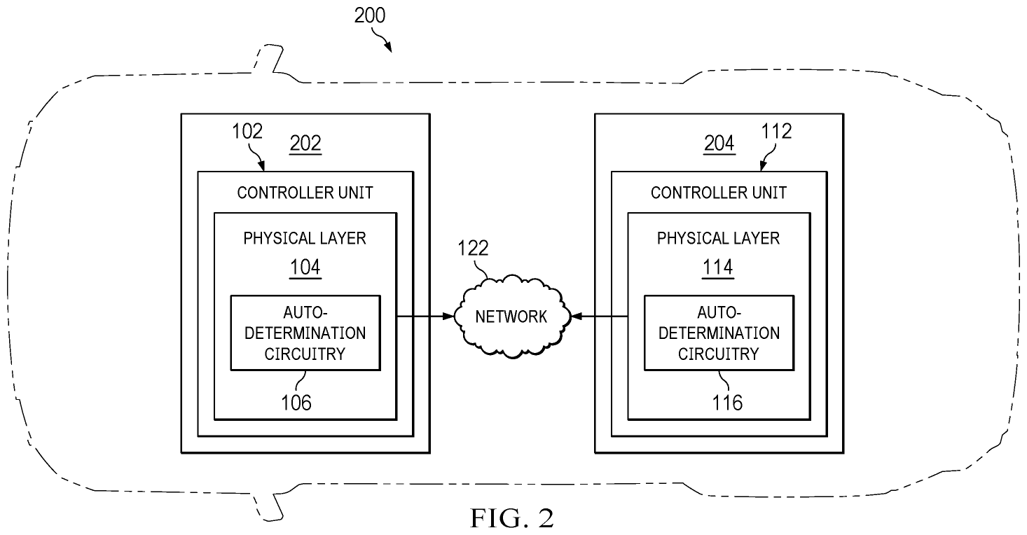

The controller units 102, 112 of FIG. 1 are a processing devices that include the corresponding PHYs 104, 114 to communicate with each other. The controller units 102, 112 may be computers, servers, edge or cloud nodes, electrical control units, electronic control modules, and/or any other processing devices. The controller units 102, 112 may be implemented in a wired or wireless system. In some examples, the controller units 102, 112 are implemented into devices within a vehicle, as further described below in conjunction with FIG. 2.

The PHYs 104, 114 of FIG. 1 transmit and/or receive data from other connected devices via the network 122 based on instructions from the controller unit 102. During startup and/or after a device is connected and/or removed from the network 122, the PHYs 104, 114 performs an initialization and/or link training protocol. As described above, to perform the initialization and/or link training protocol between the two PHYs 104, 114, one of the PHYs will operate as a leader and one of the PHYs will operate as a follower. Accordingly, the PHYS 104, 114 include the auto-determination circuitry 106, 116 to perform a leader follower determination protocol to determine which PHY will operate as the leader and which PHY will operate as the follower.

The auto-determination circuitries 106, 116 of FIG. 1 perform the leader follower determination protocol by generating toning signals. For example, the auto-determination circuitry 106 generates a first toning signal and the auto-determination circuitry 116 generates a second toning signal. The auto-determination circuitry 106, 116 generate the toning signal to be unique to the respective PHYs 104, 114. For example, the auto-determination circuitry 106 may generate a random number or may utilization a number corresponding to a unique identifier of the physical layer 104 and/or the controller unit 102. The auto-determination circuitry 106 uses the generated number to define a characteristic of the toning signal. For example, the number may correspond to an amount of delay before outputting a periodic portion of the toning signal. Additionally or alternatively, the number may correspond to an amplitude, a frequency, a shift, etc. for the toning signal. Additionally, the auto-determination circuitry 116 generates a unique toning signal using the same techniques. In this manner, the toning signal generated by the auto-determination circuitry 106 will have a high probability of being different than the toning signal generated by the auto-determination circuitry 116.

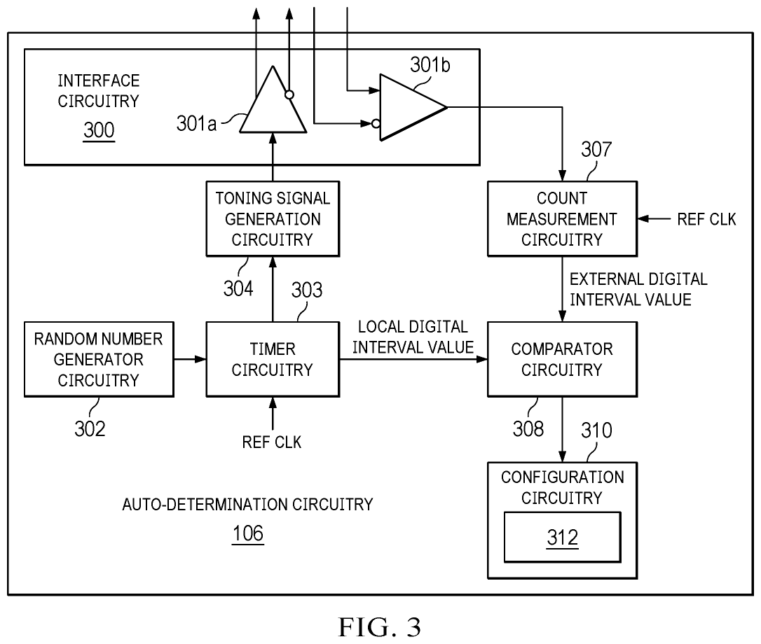

After the toning signal is generated the auto-determination circuitries 106, 116 of FIG. 1 cause transmission of the generated toning signals to each other via the network 122. The auto-determination circuitries 106, 116 can perform some echo cancellation and/or filtering to be able to obtain a toning signal via the network 122 while removing the toning signal transmitted on the network simultaneously. Accordingly, each of the auto-determination circuitries 106, 116 will transmit a locally generated toning signal and obtain a toning signal. The auto-determination circuitries 106, 116 will compare the locally generated toning signal to the obtained toning signal to determine a difference between the two signals. The auto-determination circuitries 106, 116 will operate as a follower and/or leader based on the determined difference. For example, if the toning signal generated by the auto-determination circuitry 106 includes a shorter delay, then the auto-determination circuitry 106 will determine that the locally generated signal at the PHY 104 has a shorter delay than the obtained signal and the auto-determination circuitry 116 will determine that the locally generated signal at the PHY 114 has a longer delay. If the leader follower determination protocol dictates that the PHY that generated the shorter delay will operate as the leader, the auto-determination circuitry 106 will determine that the PHY 104 should operate as a leader by setting a value in a register that defines whether to operate as a leader or follower and the auto-determinant circuitry 116 will determine that the PHY 114 should operate as a follower by setting a value in a register that defines whether to operate as a leader or follower. The leader follower determination protocol may dictate the leader and/or follower based on any characteristic of the toning signal, such as most delay, least delay, highest amplitude, lowest amplitude, longest duration, shortest duration, longest frequency, shortest frequency, highest shift, lowest shift, etc. Additionally, the auto-determination circuitry 106 performs a verification protocol to ensure that both PHYs 114, 104 agree on the follower leader roles before performing an initiation and/or link training protocol. If, during the verification protocol, the auto-determination circuitries 106 do not agree on the determined roles, the leader follower determination protocol is repeated. The auto-determination circuitry 106 is further described below in conjunction with FIG. 3.

The processing units 108, 118 of FIG. 1 execute instructions to perform functions and/or operations based on data communicated between the two physical layers 104. When the processing units 108, 118 with an external device, the processing units 108, 118 transmit instructions to send information and/or obtain received information from the corresponding MAC layer 110, 120. The MAC layers 110, 120 interfaces between the processing units 108, 118 and the corresponding PHY layers 104, 114. For example, the MAC layers 110, 120 inserts a MAC header and/or a cyclic redundancy check (CRC) in an internet protocol (IP) packet output by the processing units 108, 118. Additionally, the MAC layers 110, 120 incorporates one or more protocols for retransmission in the case of an error when transmitting and/or receiving information. The MAC layers 110, 120 instruct the corresponding PHYs 104, 114 to transmit information to an external device based on instructions from corresponding the processing units 108, 118. Additionally, the MAC layers 110, 120 pass information corresponding to obtained packets from external devices received via the corresponding PHYS 104, 114.

The example network 122 of FIG. 1 is a system of interconnected systems exchanging data. For example, the network 122 may be a shared interface or media such as an Ethernet connection. In the example of FIG. 1, the network 122 represents a physical full-duplex interface that enables transmission and reception on the same connection using a single twisted pair cable. However, the network 122 may correspond to a different connection (e.g., a different wired or wireless connection).

FIG. 2 illustrates an example vehicle 200 for implementing examples described herein. The example vehicle 200 includes a first component 202 connected to a second component 204 via the network 122 (e.g., an Ethernet twisted cable pair) of FIG. 1. The first component 202 includes the controller unit 102, the PHY 104, and the auto-determination circuitry 106 of FIG. 1. The second component 204 includes the controller unit 112, the PHY 114, and the auto-determination circuitry 116 of FIG. 1.

In the example of FIG. 2, the first component 202 is an advanced driver-assistance system (ADAS) and the second component 204 may be a camera, a sensor, a lidar system, a central gateway, etc. The first component 202 obtains and/or transmits data to the second component 204 to run operations related to driver assistance. However, the first component 202 and/or the second component 204 may be any computing device within the vehicle 200, such as an infotainment system, speakers, displays, etc. The components 202, 204 are connected via the network 122. If any other components get added to the network 122 and/or if one or more of the components 202, 204 are replaced, the auto-determination circuitry(ies) 106, 116 can perform the follower leader determination protocol to establish follower leader roles for initiation and/or link training.

FIG. 3 is a block diagram of the auto-determination circuitry 106 of FIGS. 1 and/or 2. Although FIG. 3 is described in conjunction with the auto-determination circuitry 106 of FIGS. 1 and/or 2, FIG. 3 may be described in conjunction with the auto-determination circuitry 116 of FIGS. 1 and/or 2. The example auto-determination circuitry 106 includes example interface circuitry 300, example differential circuitry 301a, 301b, example random number generator circuitry 302, example timer circuitry 303, example toning signal generation circuitry 304, example count measurement circuitry 307, example comparator circuitry 308, example configuration circuitry 310, and example configuration timer circuitry 312.

The interface circuitry 300 of FIG. 3 causes transmission of a locally generated toning signal using components of the PHY 104. For example, the interface circuitry 300 may communicate with a hybrid transmitter receiver component of the PHY 104. Additionally, the interface circuitry 300 obtains toning signals from connected devices (e.g., the controller unit 112 of FIG. 1). The interface circuitry 300 obtains the locally generated toning signal from the toning signal generation circuitry 304. The interface circuitry 300 forwards the toning signal obtained from the connected device to the comparator circuitry 308. In some examples, the interface circuits 300 includes output differential circuitry 301a and input differential circuitry 301b. The output differential circuitry 301 converts the toning signal generated by the toning signal generation circuitry 304 to two differential output signals. The input differential circuitry converts 301b differential input toning signals into a single toning signal.

The random number generator circuitry 302 of FIG. 3 generates a number. For example, the random number generator circuitry 302 can generate a random number within a range of numbers. Additionally or alternatively, the random number generator circuitry 302 may utilize a unique identifier as the number. For example, the random number generator circuitry 302 may utilize a unique identifier of the PHY 104 and/or the controller unit 102 to generate a number. The random number generator circuitry 302 may utilize the entire unique identifier, a portion of the unique identifier (e.g., the first X numbers, the last X numbers, etc.) and/or a function of the unique identifier (e.g., a modulo function corresponding to the unique identifier) to generate the number. The random number generator circuitry 302 generates the number during a leader follower determination protocol. As further described below, the generated number is used to set one or more characteristics of a toning signal to make the toning signal unique.

The example timer circuitry 303 of FIG. 3 generates a digital clock signal (e.g., a square wave) using a reference clock. The digital clock signal corresponds to a logic high voltage for a duration of time and a logic low or zero voltage signal for a duration of time. In some examples, where toning signals are based on duration of time between pulses (e.g., the delay), the timer circuitry 303 generates the digital clock signal based on a random number generated by the random number generation circuitry 302. For example, if the random number is a first number, the timer circuitry 303 will generate a first toning signal corresponding to a first delay and, if the random number is a second number, the timer circuitry 303 will generate a second toning signal corresponding to a second delay. The timer circuitry 303 outputs the digital clock signal to the toning signal generation circuitry 304 to generate a toning signal based on the digital clock signal. Additionally, the timer circuitry outputs a digital value corresponding to the local digital interval value to the comparator circuitry 308. In some examples, where the characteristic of the toning signal used for the leader follower protocol is not based on the delay, the timer circuitry 303 may be removed. In such example, the toning signal generation circuitry 304 may output a digital value corresponding to the unique characteristic of the locally generated toning signal to the comparator circuitry 308.

The toning signal generation circuitry 304 of FIG. 3 obtains the digital clock signal from the timer circuitry 303 and/or a number generated by the random number generator circuitry 302. The toning signal generation circuitry 304 generates a toning signal based on the digital clock signal and/or the generated number. For example, the toning signal generation circuitry 304 generates the toning signal with one or more characteristics that are based on the generated number. In some examples, the toning signal generation circuitry 304 generates a toning signal corresponding to an amount of delay. In such examples, the toning signal generation circuitry 304 uses the digital clock from the timer circuitry 303 to generate a toning signal that oscillates only when the digital clock signal is high. However, the generated number and/or digital clock signal can affect the amount of delay of the toning signal, the duration of the toning signal, the amplitude of the toning signal, the frequency of the toning signal, a shift in the toning signal, and/or any other characteristic of the toning signal. Thus, the generated toning signal will have a high probability of being unique to the PHY 104. After generating the toning signal, the toning signal generation circuitry 304 outputs the generated toning signal to the interface circuitry 300 to transmit the generated toning signal to connected devices via the network 122.

In some examples, to accommodate legacy devices, the toning signal generation circuitry 304 of FIG. 3 can generate the toning signal to ensure that legacy devices configured as leaders will result in a leader designation during the leader follower determination protocol. For example, if the leader follower protocol designates a device as a leader when the signal output by the device has the smallest delay between toning, the toning signal generation circuitry 304 generates the toning signal with some delay corresponding to the generated number larger than the delay of the signal output by a legacy device. In this manner, during the training protocol if a legacy device is preconfigured to be a leader, the delay of the signal from the legacy device will already be the smallest as the legacy device will not have any delay in send training sync pattern and the legacy device will be designed as a leader during the leader follower protocol even though the legacy device has not generated a toning signal based on a generated number. Additionally, legacy devices preconfigured to operate as followers will not output any signal. Accordingly, such legacy devices will have the largest delay which will cause such legacy device to not be mistakenly tagged as a leader.

The count measurement circuitry 307 of FIG. 3 uses a reference clock to convert the obtained (e.g., external) toning signal into a digital value corresponding to the delay of the obtained toning signal. For example, the count measurement circuitry 307 can count how many reference clock pulses it takes between oscillations of the obtained toning signal, which corresponds to the delay of the obtained, external toning signal. The count measurement circuitry 307 outputs an external digital interval value corresponding to the count of reference clock pulses between oscillations to the comparator circuitry 308. In some examples, the count measurement circuitry 307 can be removed or replaced with different circuitry for different toning signal characteristics. For example, if the unique toning signal characteristics correspond to amplitude of the toning signals, the count measurement circuitry 307 can be replaced with circuitry that determines the amplitude of the toning signal and converts the amplitude into a digital value.

The example comparator circuitry 308 of FIG. 3 compares one or more characteristics of the generated toning signal to the one or more characteristics of the obtained toning signal. As described above, because each auto-determination circuitry 106 generates a unique toning signal, there is a high probability that the comparator circuitry 308 can determine a difference in the one or more characteristics of the obtained toning signal and the locally generated toning signal. For example, if the leader follower determination protocol is based on an amount of delay of the toning signal, the comparator circuitry 208 compares the amount of delay for the generated toning signal to the amount of the delay in the obtained toning signal to determine which toning signal has a longer or shorter delay. For example, in FIG. 3, the comparator circuitry 308 obtains (a) the local digital interval value corresponding to the delay of the locally generated toning signal and (b) the external digital interval value corresponding to the delay of the obtained external. The comparator 308 compares the two digital values to determine which delay is larger and/or smaller. However, the comparator 308 can compare values corresponding to any characteristic of the locally generated toning signal to the obtained external toning signal. The comparator 308 outputs the comparison output to the configuration circuitry 310.

The example configuration circuitry 310 of FIG. 3 determines whether to cause the PHY 104 to operate as a leader or follower based on the result of the comparison. For example, if the leader follower determination protocol is based on the toning signal with the lowest delay being designated as a leader and all other PHYs being designed as followers, the configuration circuitry 310 determines whether the generated signal has a delay shorter than the obtained toning signal(s). In such an example, if the configuration circuitry 310 determines that the generated toning signal has a smaller delay than the obtained toning signal(s), the configuration circuitry 310 configures the PHY 104 to operate as a leader by setting a value into a register that corresponds to leader operations. If the configuration circuitry 310 determines that the generated toning signal has a larger delay than at least one obtained toning signal, the configuration circuitry 310 configures the PHY 104 to operate as a follower by setting a value into a register that corresponds to follower operation. Additionally or alternatively, the leader follower determination protocol could designate leader and/or follower roles based on any characteristic(s) of the toning signals (e.g., largest delay corresponding to leader, smallest amplitude corresponding to leader, largest amplitude corresponding to leader, smallest frequency corresponding to leader, largest frequency corresponding to leader, etc.).

Additionally, after the configuration of operating as a leader or follower, the configuration circuitry 310 of FIG. 3 performs an acknowledgment protocol to ensure that all components agree on the leader follower roles. For example, the configuration circuitry 310 can cause the interface circuitry 300 to, when configured to operate as a leader, output the toning signal and/or a training sequence after the follower designation to confirm to the other devices that the PHY 104 has been configured to operate as a leader. In such an example, the configuration circuitry 310 monitors the interface circuitry 300 to determine if a toning signal and/or training sequence has been obtained from another PHY. If the leader follower roles were correctly designated, a toning signal and/or training sequence from another PHY will not be obtained because the other PHYs will operate as followers to listen for signals and not output signals. If the leader follower roles were not correctly designated, a toning signal and/or training sequence from a PHY will be obtained and the configuration circuitry 310 can determine that an error occurred, and the leader follower determination protocol will be retriggered. In some examples, if the configuration circuitry 310 determines that, while operating as a leader, a training sequence from another PHY is obtained, the configuration circuitry 310 can switch to a follower and continue operation as a follower PHY. In another example, the configuration circuitry 310 can, when configured to operate as a follower, monitor the interface circuitry 300 to determine if a toning signal and/or training sequence has been obtained from another PHY. If the leader follower roles were correctly designated, a toning signal from another PHY will be obtained because that other PHY will operate as a leader to output a signal to the PHY 104. If the leader follower roles were not correctly designated, a toning signal and/or training sequence from another PHY will be not obtained and the configuration circuitry 310 can determine that an error occurred, and the leader follower determination protocol will be retriggered.

The example configuration timer circuitry 312 of FIG. 3 tracks a duration of time that is used during the acknowledgement protocol. For example, when the acknowledgment protocol starts, the configuration circuitry 310 monitors the network 122 for a toning signal to be obtained within a threshold amount of time tracked by the configuration timer circuitry 312. In some examples, the configuration timer circuitry 312 may be implemented by a counter that counts clock pulses.

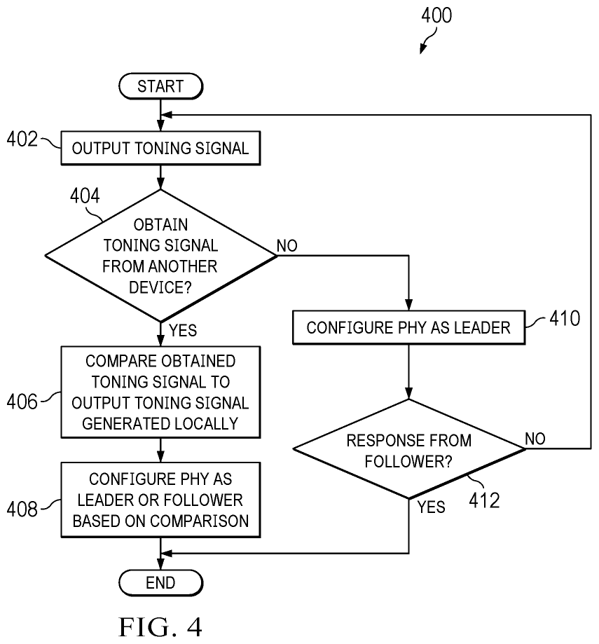

FIG. 4 is a flowchart representative of a method and/or example operations 400 that may be executed and/or instantiated by processor circuitry and/or any other circuitry of the auto-determination circuitry 106 of FIGS. 1-3 to perform a leader follower determination protocol. Although the instructions and/or operations of FIG. 4 are described in conjunction with the auto-determination circuitry 106 of FIGS. 1-3, the instructions and/or operations may be described in conjunction with the auto-determination circuitry 116 of FIG. 1 and/or any other PHY device.

The machine-readable instructions and/or the operations 400 of FIG. 4 begin at block 402, at which the toning signal generation circuitry 304 causes the interface circuitry 300 to output a toning signal to a connected device via the network 122. The interface circuitry 300 may use one or more components of the PHY 104 to transmit the toning signal. As described above, the toning signal generation circuitry 304 generates the toning signal based on a number (e.g., randomly generated and/or based on an identifier). Accordingly, the toning signal has a high probability of being unique from other toning signals. At block 404, the configuration circuitry 310 determines if a toning signal has been obtained, via the interface circuitry 300, from another device. If the configuration circuitry 310 determines that a toning signal from another device has not been obtained (block 404: NO), control continues to block 410, as further described below. If the configuration circuitry 310 determines that a toning signal from another device has been obtained (block 404: YES), control continues to block 406. At block 406, the comparator circuitry 308 compares the obtained toning signal to the output toning signal generated locally. Depending on the leader follower determination protocol, the comparator circuitry 308 can compare one or more characteristics of the generated toning signal to the one or more characteristics of the obtained toning signal to determine a difference. At block 408, the example configuration circuitry 310 configures the PHY 104 to operate as a leader or follower based on the comparison of the characteristics.

At block 410 (e.g., if a toning signal is not obtained from another device), the configuration circuitry 310 configures the PHY 104 to operate as a leader. For example, if the device that is supposed to transmit the toning signal is a legacy device, the legacy device will not output a toning signal so the PHY 104 can proceed as a leader. At block 412, the configuration circuitry 310 determines if a response from the follower has been obtained. For example, if the initial toning signal was not obtained from another device at block 404, it may be because the device is a legacy follower device or it may be due to an error. Accordingly, if the device is a legacy follower device it will transmit a response as part of the initiation and/or link training protocol. If there was an error, the other device will not transmit a response. Thus, if the configuration circuitry 310 determines that a response from the follower has been obtained (block 412: NO), the instructions end and the initiation and/or link training protocol continues. If the configuration circuitry 310 determines that a response from the follower has not been obtained (block 412: NO), control return to block 402 to restart the leader follower protocol.

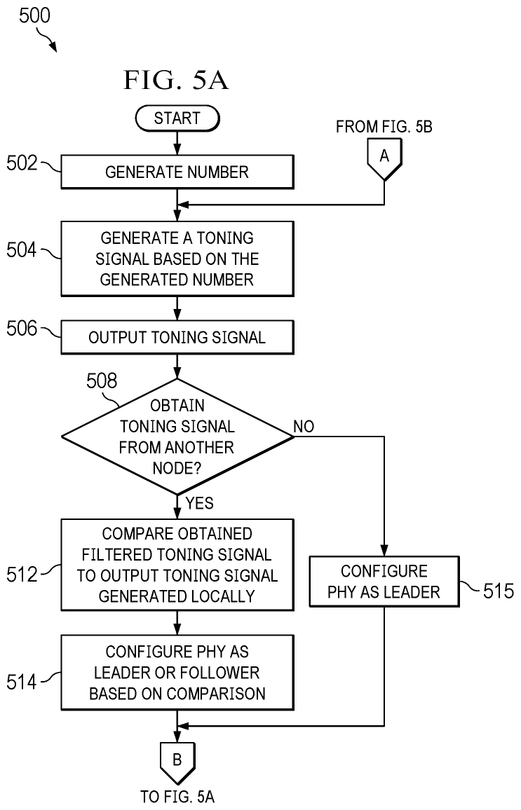

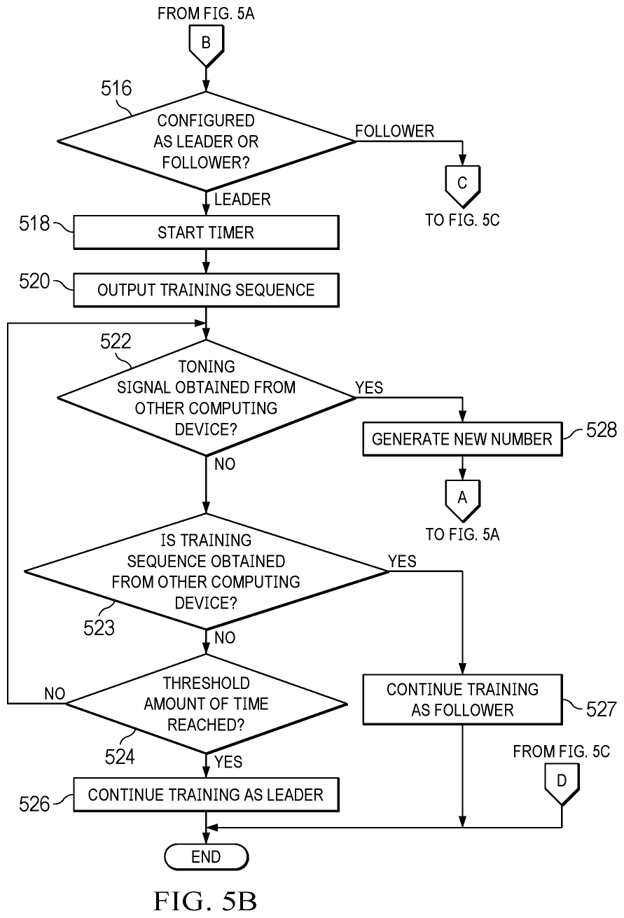

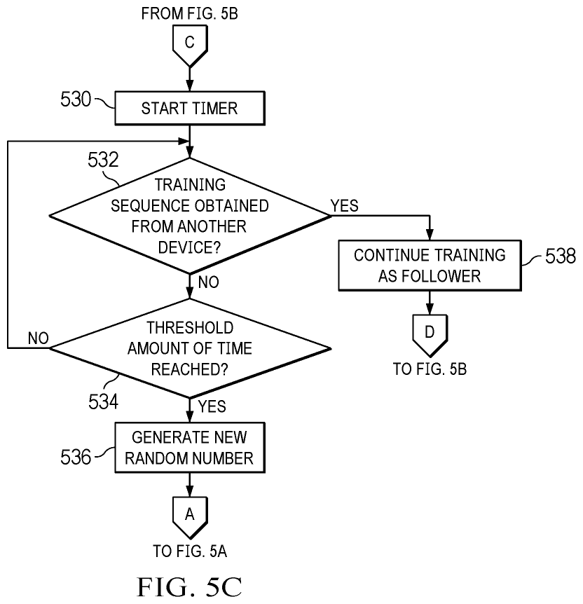

FIGS. 5A-5C illustrate a flowchart representative of a method and/or example operations 400 that may be executed and/or instantiated by processor circuitry and/or any other circuitry of the auto-determination circuitry 106 of FIGS. 1-3 to perform a leader follower determination protocol and an acknowledgement protocol. Although the instructions and/or operations of FIGS. 5A-5C are described in conjunction with the auto-determination circuitry 106 of FIGS. 1-3, the instructions and/or operations may be described in conjunction with the auto-determination circuitry 116 of FIG. 1 and/or any other PHY device.

The machine-readable instructions and/or the operations 500 of FIG. 5 begin at block 502, at which the random number generator circuitry 302 generates a random number. Alternatively, the random number generator circuitry 302 may alternatively select a number from a preset collection of numbers and/or may utilize and/or generate a number based on an identifier. At block 504, the example toning signal generation circuitry 304 generates a toning signal based on the generated number. For example, the toning signal generation circuitry 304 generates a toning signal with a characteristic (e.g., delay, frequency, phase, shift, duration, etc.) based on the generated number. In some examples, the toning signal generation circuitry 304 generates a toning signal by oscillating a signal based on a digital clock signal generated by the timer circuitry 303 corresponding to a random amount of delay, as described above in conjunction with FIG. 3. At block 506, the toning signal generation circuitry 304 causes the interface circuitry 300 to output a toning signal to a connected device via the network 122. The interface circuitry 300 may use one or more components of the PHY 104 to transmit the toning signal.

At block 508, the configuration circuitry 310 determines if a toning signal has been obtained, via the interface circuitry 300, from another device. If the configuration circuitry 310 determines that a toning signal from another device has not been obtained (block 508: NO), control continues to block 515, as further described below. If the configuration circuitry 310 determines that a toning signal from another device has been obtained (block 508: YES), control continues to block 512. In some examples, the count measurement circuitry 307 generates a digital value corresponding to a characteristic of the obtained toning signal. For example, the count measurement circuitry 307 can count the number of reference clock pulse between oscillations of the toning signal to determine an amount of delay of the obtained toning signal and generates a digital value corresponding to the count. However, the count measurement circuitry 307 can generate a value for any characteristic of the obtained toning signal. At block 512, the comparator circuitry 308 compares the obtained toning signal to the output toning signal generated locally. Depending on the leader follower determination protocol, the comparator circuitry 308 can compare one or more characteristics of the generated toning signal to the one or more characteristics of the obtained toning signal to determine a difference. In some examples, the comparator circuitry 308 compares delays of the locally generated toning signal and the obtained toning signal by comparing a first digital value from the timer circuitry 303 and a second digital value from the count measurement circuitry 207, as further described above in conjunction with FIG. 3. At block 514, the example configuration circuitry 310 configures the PHY 104 to operate as a leader or follower based on the comparison of the characteristics. At block 515 (e.g., if a toning signal is not obtained from another device), the configuration circuitry 310 configures the PHY 104 to operate as a leader. For example, if the device that is supposed to transmit the toning signal is a legacy device, the legacy device will not output a toning signal so the PHY 104 can proceed as a leader.

If the configuration circuitry 310 configures the PHY 104 to operate as a follower (block 516: FOLLOWER), control continues to block 530 of FIG. 5C. If the configuration circuitry 310 configures the PHY 104 to operate as a leader (block 516: LEADER), control continues to block 518. At block 518, the configuration circuitry 310 starts the configuration timer circuitry 312. At block 520, the toning signal generation circuitry 340 outputs the toning signal or any other signal via the interface circuitry 300. Outputting the toning signal signifies to the other connected devices that the PHY 104 is operating as a leader. At block 522, the configuration circuitry 310 determines if a toning signal has been obtained from another connected device via the interface circuitry 300. For example, if there was an error that occurred during the initial leader/follower protocol, the other PHY device may transmit a subsequent toning signal even though the leader/follower protocol has ended. Thus, the configuration circuitry 310 monitors for obtained toning signals to determine that the previous leader/follower protocol resulted in an error and restarts the leader/follower protocol.

If the configuration circuitry 310 determines that a toning signal has been obtained from another computing device (block 522: YES), control continues to block 528, as further described below. If the configuration circuitry 310 determines that a toning signal has not been obtained from another computing device (block 522: NO), control continues to block 524. At block 523, the configuration circuitry 310 determines if a training sequence has been obtained from the other computing device. Because only one device can operate as a leader, if the configuration circuitry 310 determines that a toning signal has been obtained, then the configuration circuitry 310 will determine that the leader follower determination protocol failed because at least two devices configured to operate as leaders. Accordingly, the configuration circuitry 310 will determine that the other device is operating as the leader. If the configuration circuitry 310 determines that a training sequence has not been obtained from another computing device (block 523: NO), control continues to block 524. If the configuration circuitry 310 determines that a training sequence has been obtained from another computing device (block 523: YES), control continues to block 527.

At block 524, the configuration circuitry 310 determines if the configuration timer circuitry 312 has reached a threshold amount of time. If the configuration circuitry 310 determines that the configuration timer circuitry 312 has not reached a threshold amount of time (block 524: NO), control returns to block 522. If the configuration circuitry 310 determines that the configuration timer circuitry 312 has reached a threshold amount of time (block 524: YES), control continues to block 526. At block 526, the PHY 104 initiates initialization and/or link training as a leader. At block 528, after a toning signal was obtained from another computing device, the random number generator circuitry 302 generates a new number and control returns to block 504 of FIG. 5A. At block 527 (e.g., if the training sequence was obtained from another computing device), the configuration circuitry 310 reconfigures the PHY 104 to operate as a follower and continue training as the follower based on the obtained training sequence.

At block 530, after the configuration circuitry 310 configures the PHY 104 to operate as a follower, the configuration circuitry 310 starts the configuration timer circuitry 312. At block 532, the configuration circuitry 310 determines if a training sequence has been obtained from another connected device via the interface circuitry 300. Because one device operates as a leader, if the configuration circuitry 310 determines that a training sequence has been not obtained, then the configuration circuitry 310 will determine that the leader follower determination protocol failed because no device has been structured to operate as a leader. Accordingly, the configuration circuitry 310 will determine that the leader follower protocol should restart.

If the configuration circuitry 310 determines that a training sequence has been obtained from another computing device (block 532: YES), control continues to block 538, as further described below. If the configuration circuitry 310 determines that a toning signal has not been obtained from another computing device (block 532: NO), control continues to block 534. At block 534, the configuration circuitry 310 determines if the configuration timer circuitry 312 has reached a threshold amount of time. If the configuration circuitry 310 determines that the configuration timer circuitry 312 has not reached a threshold amount of time (block 534: NO), control returns to block 532. If the configuration circuitry 310 determines that the configuration timer circuitry 312 has reached a threshold amount of time (block 534: YES), control continues to block 536. At block 536, after a threshold amount of time has been reached, the random number generator circuitry 302 generates a new number and control returns to block 504 of FIG. 5A. At block 338, after determining that a toning signal has been obtained from another device, the PHY 104 initiates initialization and/or link training as a follower.

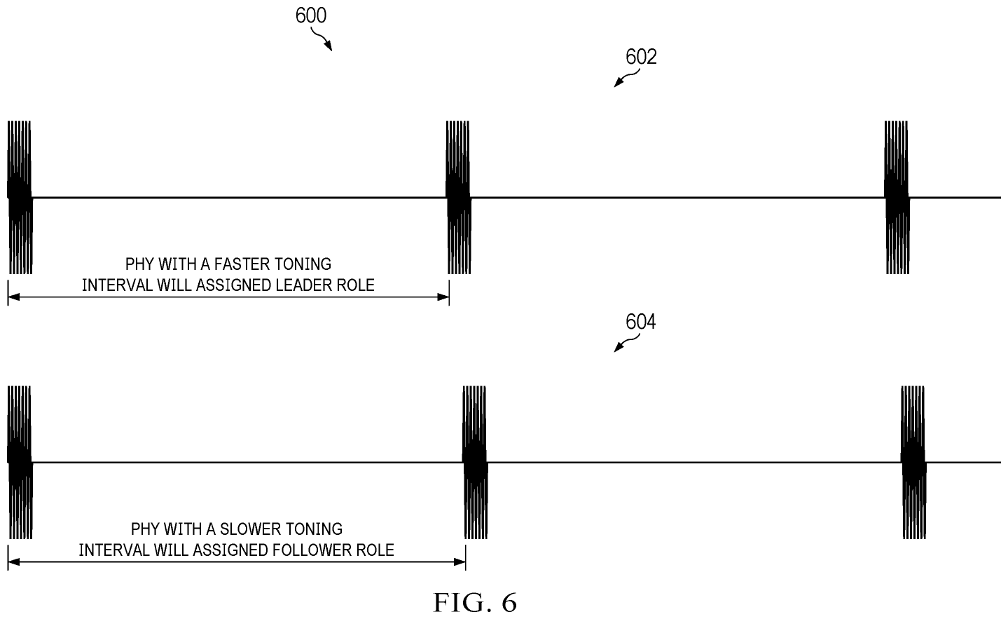

FIG. 6 is an example timing diagram 600 illustrating two toning signals that may be generated by the PHYs 104, 114 of FIG. 1. The timing diagram 600 includes a first example toning signal 602 and a second example toning signal 604. The first toning signal 602 is a signal that may be output by the PHY 104 and the second toning signal 604 is a signal that may be output by the PHY 114. The timing diagram 600 is described in conjunction with a leader follower determination protocol where the PHY that outputs the toning signal with the shorter delay is to be a leader and the remaining PHY(s) is/are to be follower(s). However, the leader follower determination protocol may correspond to any characteristic corresponding to a leader or a follower.

As shown in the timing diagram 600, the amount of delay between periodic pulses for the first toning signal 602 is shorter than the amount of delay between periodic pulses for the second toning signal 604. The PHY 104 outputs the first toning signal 602 and obtains the second toning signal 604 via the network 122. Thus, PHY 104 determines that the locally generated toning signal 602 has a smaller delay than the obtained toning signal 604. Likewise, the PHY 114 outputs the second toning signal 604 and obtains the first toning signal 602 via the network 122. Thus, the PHY 114 determines that the locally generated toning signal 604 has a larger delay than the obtained toning signal 602. Thus, the PHY 104 operates as the leader and the PHY 114 operates as the follower.

The periodic portion of the first toning signal 602 and/or the second toning signal 604 could be any type of periodic signal. In some examples, the periodic portion of the toning signal corresponds to a slow transition time (e.g., such as a triangle wave or a sine wave). In this manner, if link training has not been performed to train an echo cancellation circuit that includes the cancellation of a reflective signal from a channel, the echo cancellation can cancel the signal from a local transmitter. Accordingly, a toning signal with a slow transition time can minimize reflection. However, any periodic signal can be used.

An example manner of implementing the auto-determination circuitry 106 of FIG. 1 is illustrated in FIG. 3. However, one or more of the elements, processes and/or devices illustrated in FIG. 3 may be combined, divided, re-arranged, omitted, eliminated and/or implemented in any other way.

Further, the interface circuitry 300, the random number generator circuitry 302, the example timer circuitry 303, the toning signal generation circuitry 304, the count measurement circuitry 307, the comparator circuitry 308, the configuration circuitry 310, and/or the configuration timer circuitry 312 of FIG. 3 may be implemented by hardware, software, firmware and/or any combination of hardware, software and/or firmware. As a result, for example, any of the interface circuitry 300, the random number generator circuitry 302, the example timer circuitry 303, the toning signal generation circuitry 304, the count measurement circuitry 307, the comparator circuitry 308, the configuration circuitry 310, and/or the configuration timer circuitry 312 of FIG. 3 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)).

When reading any of the apparatus or system claims of this patent to cover a purely software and/or firmware implementation, at least one of the interface circuitry 300, the random number generator circuitry 302, the example timer circuitry 303, the toning signal generation circuitry 304, the count measurement circuitry 307, the comparator circuitry 308, the configuration circuitry 310, and/or the configuration timer circuitry 312 of FIG. 3 is/are hereby expressly defined to include a non-transitory computer readable storage device or storage disk such as a memory, a digital versatile disk (DVD), a compact disk (CD), a Blu-ray disk, etc., including the software and/or firmware. Further still, the interface circuitry 300, the random number generator circuitry 302, the example timer circuitry 303, the toning signal generation circuitry 304, the count measurement circuitry 307, the comparator circuitry 308, the configuration circuitry 310, and/or the configuration timer circuitry 312 of FIG. 3 may include one or more elements, processes and/or devices in addition to, or instead of, those illustrated in FIG. 3, and/or may include more than one of any or all of the illustrated elements, processes, and devices. As used herein, the phrase “in communication,” including variations thereof, encompasses direct communication and/or indirect communication through one or more intermediary components, and does not require direct physical (e.g., wired) communication and/or constant communication, but rather also includes selective communication at periodic intervals, scheduled intervals, aperiodic intervals, and/or one-time events.

Flowcharts representative of example hardware logic, machine-readable instructions, hardware implemented state machines, and/or any combination thereof for implementing the auto-determination circuitry 106 of FIGS. 1, 2 and/or 3 are shown in FIGS. 4-5C. The machine-readable instructions may be one or more executable programs or portion(s) of an executable program for execution by a computer processor. The program may be embodied in software stored on a non-transitory computer readable storage medium such as a CD-ROM, a floppy disk, a hard drive, a DVD, a Blu-ray disk, or a memory associated with the processor, but the entire program and/or parts thereof could alternatively be executed by a device other than the processor and/or embodied in firmware or dedicated hardware.

Further, although the example program is described with reference to the flowchart illustrated in FIGS. 4-5C, many other methods of implementing the auto-determination circuitry 106 may alternatively be used. For example, the order of execution of the blocks may be changed, and/or some of the blocks described may be changed, eliminated, or combined. Also or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine-readable instructions described herein may be stored in one or more of a compressed format, an encrypted format, a fragmented format, a compiled format, an executable format, a packaged format, etc. Machine-readable instructions as described herein may be stored as data (e.g., portions of instructions, code, representations of code, etc.) that may be utilized to create, manufacture, and/or produce machine executable instructions. For example, the machine-readable instructions may be fragmented and stored on one or more storage devices and/or computing devices (e.g., servers). The machine-readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine-readable instructions may be stored in multiple parts, which are individually compressed, encrypted, and stored on separate computing devices, in which the parts when decrypted, decompressed, and combined form a set of executable instructions that implement a program such as that described herein.

In another example, the machine-readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine-readable instructions may be configured (e.g., settings stored, data input, network addresses recorded, etc.) before the machine-readable instructions and/or the corresponding program(s) can be executed in whole or in part. As a result, the described machine-readable instructions and/or corresponding program(s) encompass such machine-readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 4-5C may be implemented using executable instructions (e.g., computer and/or machine-readable instructions) stored on a non-transitory computer and/or machine-readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

Descriptors “first,” “second,” “third,” etc. are used herein when identifying multiple elements or components which may be referred to separately. Unless otherwise specified or known based on their context of use, such descriptors do not impute any meaning of priority, physical order, or arrangement in a list, or ordering in time but are merely used as labels for referring to multiple elements or components separately for case of understanding the described examples. In some examples, the descriptor “first” may be used to refer to an element in the detailed description, while the same element may be referred to in a claim with a different descriptor such as “second” or “third.” In such instances, such descriptors are used merely for case of referencing multiple elements or components.

In the description and in the claims, the terms “including” and “having” and variants thereof are to be inclusive in a manner similar to the term “comprising” unless otherwise noted. Unless otherwise stated, “about,” “approximately,” or “substantially” preceding a value means +/−10 percent of the stated value. In another example, “about,” “approximately,” or “substantially” preceding a value means +/−5 percent of the stated value. In another example, “about,” “approximately,” or “substantially” preceding a value means +/−1 percent of the stated value.

The terms “couple” “coupled”, “couples”, and variants thereof, as used herein, may cover connections, communications, or signal paths that enable a functional relationship consistent with this description. For example, if device A generates a signal to control device B to perform an action, in a first example device A is coupled to device B, or in a second example device A is coupled to device B through intervening component C if intervening component C does not substantially alter the functional relationship between device A and device B such that device B is controlled by device A via the control signal generated by device A. Moreover, the terms “couple,” “coupled”, “couples”, or variants thereof, includes an indirect or direct electrical or mechanical connection.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

Although not all separately labeled in the FIGS. 1-7, components or elements of systems and circuits illustrated therein have one or more conductors or terminus that allow signals into and/or out of the components or elements. The conductors or terminus (or parts thereof) may be referred to herein as pins, pads, terminals (including input terminals, output terminals, reference terminals, and ground terminals, for instance), inputs, outputs, nodes, and interconnects.

As used herein, a “terminal” of a component, device, system, circuit, integrated circuit, or other electronic or semiconductor component, generally refers to a conductor such as a wire, trace, pin, pad, or other connector or interconnect that enables the component, device, system, etc., to electrically and/or mechanically connect to another component, device, system, etc. A terminal may be used, for instance, to receive or provide analog or digital electrical signals (or simply signals) or to electrically connect to a common or ground reference. Accordingly, an input terminal or input is used to receive a signal from another component, device, system, etc. An output terminal or output is used to provide a signal to another component, device, system, etc. Other terminals may be used to connect to a common, ground, or voltage reference, e.g., a reference terminal or ground terminal. A terminal of an IC or a PCB may also be referred to as a pin (a longitudinal conductor) or a pad (a planar conductor). A node refers to a point of connection or interconnection of two or more terminals. An example number of terminals and nodes may be shown. However, depending on a particular circuit or system topology, there may be more or fewer terminals and nodes. However, in some instances, “terminal,” “node,” “interconnect,” “pad,” and “pin” may be used interchangeably.

Example methods, apparatus, systems, and articles of manufacture corresponding to facilitate determination of leader and follower for a shared interface are described herein. Further examples and combinations thereof include the following: A first physical layer comprising interface circuitry configured to transmit a first signal to a second physical layer, comparator circuitry configured to compare a second signal from the second physical layer to the first signal, and configuration circuitry configured to facilitate operation as a leader or a follower based on the comparison.

Example 2 includes the first physical layer of example 1, further including signal generator circuitry configured to generate the first signal based on at least one of a generated number or a characteristic of the first physical layer or a device that implements the first physical layer.

Example 3 includes the first physical layer of example 1, wherein the first signal corresponds to a first characteristic and the second signal corresponds to a second characteristic different than the first characteristic, the comparator circuitry to compare the first characteristic to the second characteristic.

Example 4 includes the first physical layer of example 1, wherein the interface circuitry is to obtain the second signal via a shared wired bus, and transmit the first signal via the shared wired bus.

Example 5 includes the first physical layer of example 1, wherein, when operating as the leader the interface circuitry is configured to output a third signal to the second physical layer, and the configuration circuitry is configured to, when a signal has not been obtained from the second physical layer within a threshold amount of time, initiate training configured as the leader.

Example 6 includes the first physical layer of example 1, wherein, when operating as the leader the interface circuitry is configured to output a third signal to the second physical layer, and the configuration circuitry is configured to, when a signal has been obtained from the second physical layer within a threshold amount of time, redetermine operation as the leader or the follower.

Example 7 includes the first physical layer of example 1, wherein, when operating as the follower, the configuration circuitry is configured to, when a signal has been obtained from the second physical layer within a threshold amount of time, initiate training configured as the follower.

Example 8 includes the first physical layer of example 1, wherein, when operating as the follower, the configuration circuitry is configured to, when a signal has not obtained from the second physical layer within a threshold amount of time, redetermine operation as the leader or the follower.

Example 9 includes a method comprising generating, by executing an instruction with a first physical layer, a first signal, transmitting the first signal to a second physical layer, comparing, by executing an instruction with the first physical layer, a second signal from the second physical layer to the first signal, and configuring, by executing an instruction with the first physical layer, the first physical layer to operate as a leader or a follower based on the comparison.

Example 10 includes the method of example 9, further including generating the first signal based on at least one of a generated number or a characteristic of the first physical layer or a device that implements the first physical layer.

Example 11 includes the method of example 9, wherein the first signal corresponds to a first characteristic and the second signal corresponds to a second characteristic different than the first characteristic, wherein compare of the first signal and the second signal includes comparing the first characteristic to the second characteristic.

Example 12 includes the method of example 9, further including obtaining the second signal via a shared wired bus, and transmitting the first signal via the shared wired bus.

Example 13 includes the method of example 9, further including, when operating as the leader outputting a third signal to the second physical layer, and when a signal has not been obtained from the second physical layer within a threshold amount of time, initiating training configured as the leader.

Example 14 includes the method of example 9, further including, when operating as the leader outputting a third signal to the second physical layer, and when a signal has been obtained from the second physical layer within a threshold amount of time, redetermining operation as the leader or the follower.

Example 15 includes the method of example 9, further including, when operating as the follower and a signal has been obtained from the second physical layer within a threshold amount of time, initiating training configured as the follower.

Example 16 includes the method of example 9, further including, when operating as the follower and a signal has not obtained from the second physical layer within a threshold amount of time, redetermining operation as the leader or the follower.

Example 17 includes a non-transitory computer readable storage medium comprising instructions which cause a first physical layer to at least cause transmission of a first signal to a second physical layer, compare a second signal from the second physical layer to the first signal, and configure the first physical layer as a leader or a follower based on the comparison.

Example 18 includes the non-transitory computer readable storage medium of example 17, wherein the instructions cause the first physical layer to the first signal based on at least one of a generated number or a characteristic of the first physical layer or a device that implements the first physical layer.

Example 19 includes the non-transitory computer readable storage medium of example 17, wherein the first signal corresponds to a first characteristic and the second signal corresponds to a second characteristic different than the first characteristic, the instructions to cause the first physical layer to compare the first characteristic to the second characteristic.

Example 20 includes the non-transitory computer readable storage medium of example 17, wherein the instructions cause the first physical layer to obtain the second signal via a shared wired bus, and cause transmission the first signal via the shared wired bus.

Modifications are possible in the described embodiments, and other embodiments are possible, within the scope of the claims.

What is claimed is:

1. A first physical layer comprising:
interface circuitry configured to transmit a first signal to a second physical layer;
comparator circuitry configured to compare a second signal from the second physical layer to the first signal; and
configuration circuitry configured to facilitate operation as a leader or a follower based on the comparison.

2. The first physical layer of claim 1, further including signal generator circuitry configured to generate the first signal based on at least one of a generated number or a characteristic of the first physical layer or a device that implements the first physical layer.

3. The first physical layer of claim 1, wherein the first signal corresponds to a first characteristic and the second signal corresponds to a second characteristic different than the first characteristic, the comparator circuitry to compare the first characteristic to the second characteristic.

4. The first physical layer of claim 1, wherein the interface circuitry is to:
obtain the second signal via a shared wired bus; and
transmit the first signal via the shared wired bus.

5. The first physical layer of claim 1, wherein, when operating as the leader:
the interface circuitry is configured to output a third signal to the second physical layer; and
the configuration circuitry is configured to, when a signal has not been obtained from the second physical layer within a threshold amount of time, initiate training configured as the leader.

6. The first physical layer of claim 1, wherein, when operating as the leader:
the interface circuitry is configured to output a third signal to the second physical layer; and
the configuration circuitry is configured to, when a signal has been obtained from the second physical layer within a threshold amount of time, redetermine operation as the leader or the follower.

7. The first physical layer of claim 1, wherein, when operating as the follower, the configuration circuitry is configured to, when a signal has been obtained from the second physical layer within a threshold amount of time, initiate training configured as the follower.

8. The first physical layer of claim 1, wherein, when operating as the follower, the configuration circuitry is configured to, when a signal has not obtained from the second physical layer within a threshold amount of time, redetermine operation as the leader or the follower.

9. A method comprising:
generating, by executing an instruction with a first physical layer, a first signal;
transmitting the first signal to a second physical layer;
comparing, by executing an instruction with the first physical layer, a second signal from the second physical layer to the first signal; and
configuring, by executing an instruction with the first physical layer, the first physical layer to operate as a leader or a follower based on the comparison.

10. The method of claim 9, further including generating the first signal based on at least one of a generated number or a characteristic of the first physical layer or a device that implements the first physical layer.

11. The method of claim 9, wherein the first signal corresponds to a first characteristic and the second signal corresponds to a second characteristic different than the first characteristic, wherein compare of the first signal and the second signal includes comparing the first characteristic to the second characteristic.

12. The method of claim 9, further including:
obtaining the second signal via a shared wired bus; and
transmitting the first signal via the shared wired bus.

13. The method of claim 9, further including, when operating as the leader:
outputting a third signal to the second physical layer; and
when a signal has not been obtained from the second physical layer within a threshold amount of time, initiating training configured as the leader.

14. The method of claim 9, further including, when operating as the leader:
outputting a third signal to the second physical layer; and
when a signal has been obtained from the second physical layer within a threshold amount of time, redetermining operation as the leader or the follower.

15. The method of claim 9, further including, when operating as the follower and a signal has been obtained from the second physical layer within a threshold amount of time, initiating training configured as the follower.

16. The method of claim 9, further including, when operating as the follower and a signal has not obtained from the second physical layer within a threshold amount of time, redetermining operation as the leader or the follower.

17. A non-transitory computer readable storage medium comprising instructions which cause a first physical layer to at least:
cause transmission of a first signal to a second physical layer;
compare a second signal from the second physical layer to the first signal; and
configure the first physical layer as a leader or a follower based on the comparison.

18. The non-transitory computer readable storage medium of claim 17, wherein the instructions cause the first physical layer to the first signal based on at least one of a generated number or a characteristic of the first physical layer or a device that implements the first physical layer.

19. The non-transitory computer readable storage medium of claim 17, wherein the first signal corresponds to a first characteristic and the second signal corresponds to a second characteristic different than the first characteristic, the instructions to cause the first physical layer to compare the first characteristic to the second characteristic.

20. The non-transitory computer readable storage medium of claim 17, wherein the instructions cause the first physical layer to:
obtain the second signal via a shared wired bus; and
cause transmission the first signal via the shared wired bus.
